(19) United States
(12) Patent Application Publication
(10) Pub. No.: US 2013/0166394 A1
(43) Pub. Date: Jun. 27, 2013

(54) SALIENCY-BASED EVALUATION OF WEBPAGE DESIGNS AND LAYOUTS

(71) Applicants: Elizabeth F. Churchill, San Francisco, CA (US); Vidhya Navalpakkam, Santa Clara, CA (US); Shanmugasundaram Ravikumar, Sunnyvale, CA (US)

(72) Inventors: Elizabeth F. Churchill, San Francisco, CA (US); Vidhya Navalpakkam, Santa Clara, CA (US); Shanmugasundaram Ravikumar, Sunnyvale, CA (US)

(73) Assignee: Yahoo! Inc., Sunnyvale, CA (US)

(21) Appl. No.: 13/334,303

(22) Filed: Dec. 22, 2011

(51) Int. Cl. G06Q 30/02; G06F 15/18; G06N 5/02

(52) U.S. Cl. 705/14.72; 706/52; 706/12

(57) ABSTRACT

Evaluating a web design includes: receiving input that includes page elements; deriving a plurality of key page elements from the input; running a saliency model on the input to derive hot spots representing those items that are most likely to initially grab (or obtain) a viewer's attention; comparing positions of the hot spots to placement of the plurality of the key page elements to determine effectiveness of the placement of the key page elements; and presenting a saliency map depicting the hot spots in the page elements.

### CROSS-REFERENCE TO RELATED APPLICATIONS

None.

### STATEMENT REGARDING FEDERALLY SPONSORED-RESEARCH OR DEVELOPMENT

None.

### INCORPORATION BY REFERENCE OF MATERIAL SUBMITTED ON A COMPACT DISC

None.

### FIELD OF THE INVENTION

The invention disclosed broadly relates to the field of web page design, and more particularly relates to the field of evaluation of web page design.

### BACKGROUND OF THE INVENTION

State of the art methods for evaluating web page design and layouts are slow, expensive, require manual intervention from designers, and are data-intensive. They generally require data collection from several thousands of users, followed by an analysis of the click-through rate (“CTR”) in order to determine whether or not a new design/layout is effective.

Saliency refers to the state or quality of an item that makes it stand out relative to its neighboring items. In simpler terms, saliency is what catches the eye. There are a few publications on saliency models, such as “Feature Combination Strategies For Saliency-Based Visual Attention Systems,” by Laurent Itti and Christof Koch; “A Model Of Saliency-Based Visual Attention For Rapid Scene Analysis” by Itti, Koch, and Neibur IEEE PAMI 1998; and “Saliency Detection: A Spectral Residual Approach” by Xiaudi Hou and Liqing Zhang, Department of Computer Science, Shanghai Jiao Tong University, CVPR 2007. These models have only been tested on a small scale (less than hundred users) and have not been tested on web pages. There have been no attempts made to log saliency information on a large scale (on millions of users), to analyze the saliency information in relation to click logs, and to apply the saliency information to large scale web page and ad design/layout evaluation and optimization

Referring now in specific detail to the drawings and to FIG. 1 in particular, there is provided a simplified pictorial illustration of current data-driven methods for studying user attention. The methods 106 displayed here are: eye tracking, toolbars, and click logs. Eye tracking methods involve the use of an eye tracker to noninvasively track eye gaze as the user views a display. Commercial eye trackers allow high accuracy in tracking the eye, and at a fine temporal resolution of a few tens of milliseconds. They track the eye as it moves, and log the data in terms of the instantaneous eye position and time stamp. These raw eye tracks can then be analyzed to reveal how the user visually scans the page, what the user notices and where the user spends more time on a display.

While eye tracking offers an excellent way to track user attention at the millisecond timescale on a display, it suffers the following shortcomings. Commercial eye trackers are expensive (costing more than $10,000 each). This eye tracking method is a good methodology for tracking user attention on a small scale, but because it requires that users be brought into a lab for observation/eye tracking, it is not scalable. Moreover, data collection from 100 users can take more than a week, and hence this methodology is time-consuming.

The toolbar method allows tracking mouse movements, which is considered to be a weak proxy for eye gaze. The pros of this methodology are that it is more scalable than eye tracking and it is also cheaper. The cons are that mouse tracks are inherently noisy (there is wide variability in mouse usage patterns across users), and the relationship between mouse and eye gaze/attention is not well understood.

Finally, click logs offer another way to track user attention on the web. The pros of this approach are that it is highly scalable, and avoids the sampling biases that may arise from eye tracking and toolbars. The cons, however, are that click logs offer poor temporal resolution of several seconds (compared to eye tracking at a millisecond resolution), and reflect user choice which is an after-effect of user attention. For example, the user may attend to several items on the page but may not click on anything. In such cases, click logs cannot offer any information about the user's attention while on the page.

These methods can advantageously mine data for interesting patterns, consider a user's state of mind, and consider his/her natural behavior. The drawbacks are that they require a great deal of user training data over a long period of time; hence they are slow and expensive. Although these current methods 106 provide a great and valuable insight into what catches the user's eye, they are not suited for large scale implementation. The greater the depth of understanding 104 they provide, the less scalable they are. The arrows in FIG. 1 show the inverse relationship between scalability 102 and depth of understanding 104 with many of the current methods 106 used today.

FIG. 3 shows an example of what makes an item salient (stand out). One saliency feature is how different an item is from the items surrounding it. For example, the salient item 310 is a different color (although shown here in grayscale) and a different shape from its neighbors. The non-salient item 320 blends in with its neighbors. FIG. 4 shows another example of saliency. The nearby units compete strongly for attention, while the more distant units are weaker.

FIGS. 5A and 5B show some other feature differences that guide a user's attention. Features such as color, orientation, size, intensity, motion, and flicker are effective in drawing the eye. Some features that do not have a strong effect on visual saliency are intersections and mirror images.

### SUMMARY OF THE INVENTION

Briefly, according to an embodiment of the invention a method for evaluating a web design includes steps or acts of: receiving input that includes page elements; deriving a plurality of key page elements from the input; running a saliency model on the input to derive hot spots representing those items that are most likely to initially grab a viewer's attention; comparing positions of the hot spots to placement of the plurality of the key page elements to determine effectiveness of the placement of the key page elements; and presenting a saliency map depicting the hot spots in the page elements.

According to another embodiment of the present invention, a system for evaluating web design includes: a memory with computer program instructions for: receiving input that includes page elements; deriving a plurality of key page elements from the input; running a saliency model on the input to derive hot spots representing those items that are most likely to initially grab a viewer's attention; comparing positions of the hot spots to placement of the plurality of the key page elements to determine effectiveness of the placement of the key page elements; and presenting a saliency map depicting the hot spots in the page elements. The system further includes a processor device for carrying out the method steps.

In another embodiment of the present invention, a computer readable storage medium includes instructions for executing the method steps above.

The method can also be implemented as machine executable instructions executed by a programmable information processing system or as hard coded logic in a specialized computing apparatus such as an application-specific integrated circuit (ASIC).

### BRIEF DESCRIPTION OF THE SEVERAL VIEWS OF THE DRAWINGS

To describe the foregoing and other exemplary purposes, aspects, and advantages, we use the following detailed description of an exemplary embodiment of the invention with reference to the drawings, in which:

FIG. 1 is a simplified illustration of the inverse relationship between scale and depth of understanding when applied to current method, according to the known art;

FIG. 2 is a simplified illustration of the saliency model of visual attention, according to an embodiment of the present invention;

FIG. 3 shows an example of what makes an item salient, according to the known art;

FIG. 4 shows another example of what makes an item salient, according to the known art;

FIGS. 5A and 5B are simplified illustrations of how different feature differences affect visual saliency, according to the known art;

FIG. 6 is a saliency model, according to the known art;

FIG. 7 is a screenshot of a web page, according to the known art;

FIG. 8 shows the screenshot of FIG. 7 with hotspots marking the salient items, according to an embodiment of the present invention;

FIG. 9 presents results of application of the saliency model, according to an embodiment of the present invention;

FIG. 10 presents an evaluation of the saliency of a page item, according to an embodiment of the present invention;

FIG. 11 shows a predictive attention heat map, according to an embodiment of the present invention;

FIG. 12 is a flowchart of a method according to an embodiment of the present invention;

FIG. 13 is a flowchart of a method according to an embodiment of the present invention;

FIG. 14 is a flowchart of a method according to an embodiment of the present invention;

FIG. 15 is a flowchart of a method according to an embodiment of the present invention;

FIG. 16 shows an exemplary user interface for implementing the saliency method, according to an embodiment of the present invention;

FIG. 17 shows exemplary results of the saliency method, according to an embodiment of the present invention; and

FIG. 18 shows a high-level block diagram of a computer system configured to implement an embodiment of the present invention;

FIG. 19 is a summary statistics report, according to an embodiment of the present invention;

FIG. 20 is an exemplary screenshot showing the location of a bounding box, according to an embodiment of the present invention; and

FIG. 21 is an exemplary user interface for entering the coordinates of the bounding box, according to an embodiment of the present invention.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

Before describing in detail embodiments that are in accordance with the present invention, it should be observed that the embodiments reside primarily in combinations of method steps and system components related to systems and methods for placing computation inside a communication network. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention. In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of” a,” “an,” and “the” includes plural references. The meaning of “in” includes “in” and “on.”

A saliency-based method.

We describe a novel saliency-based method for fast, inexpensive, automated, and scalable evaluation and optimization of webpage designs and layouts, and advertisement and brand effectiveness. This method, which we will describe in detail below, is applicable to a number of different applications, such as advertisement layout/effectiveness, webpage creative content, and optimizing webpage layout.

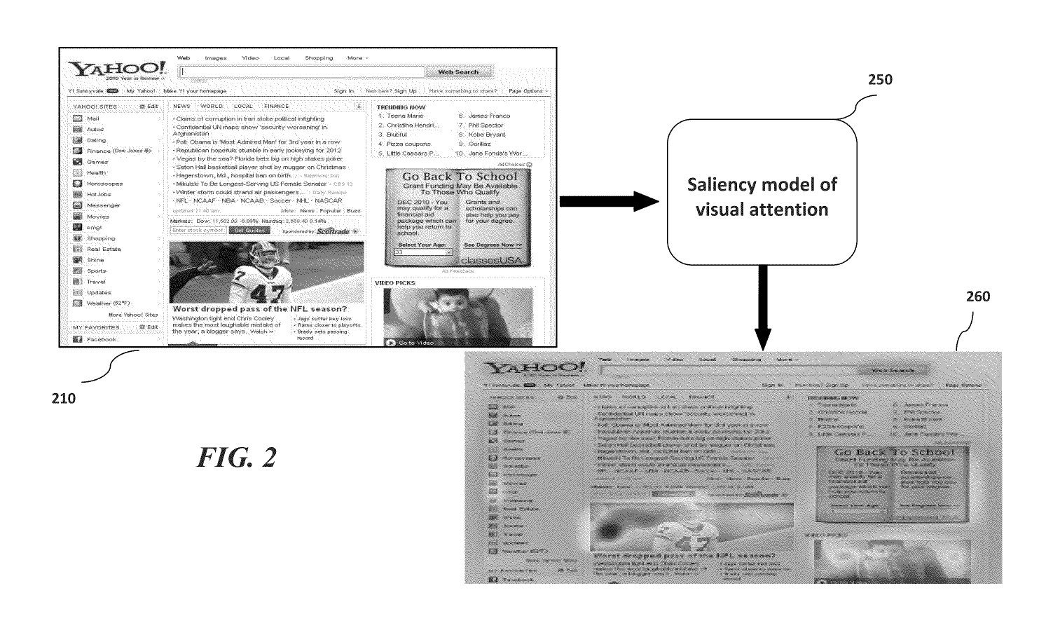

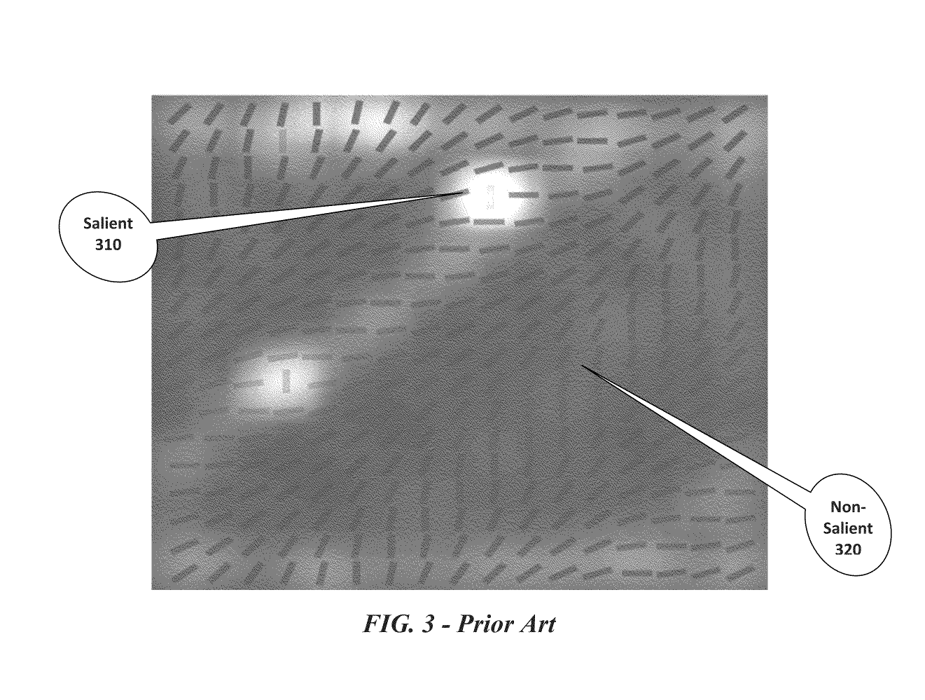

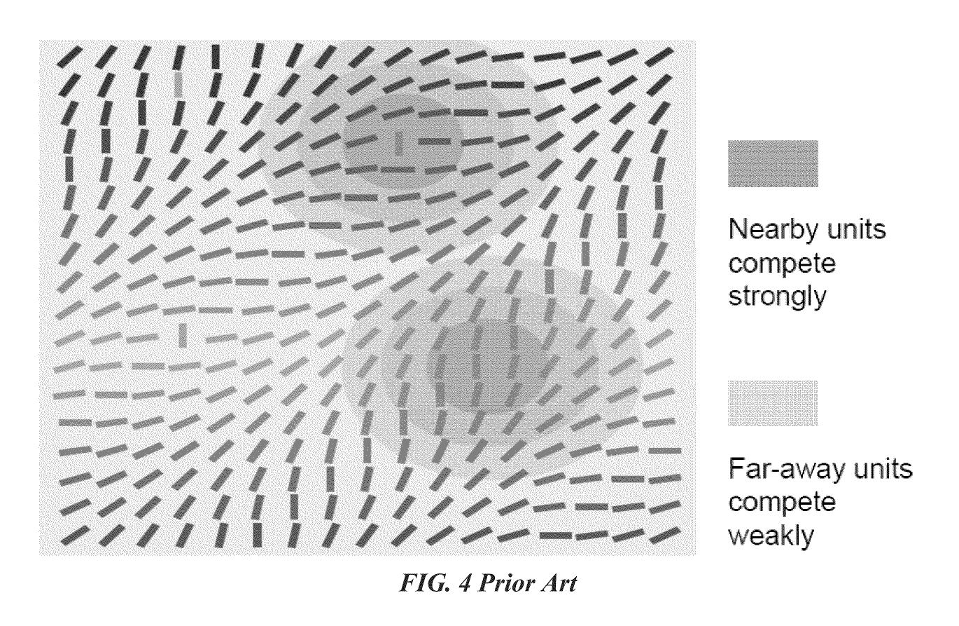

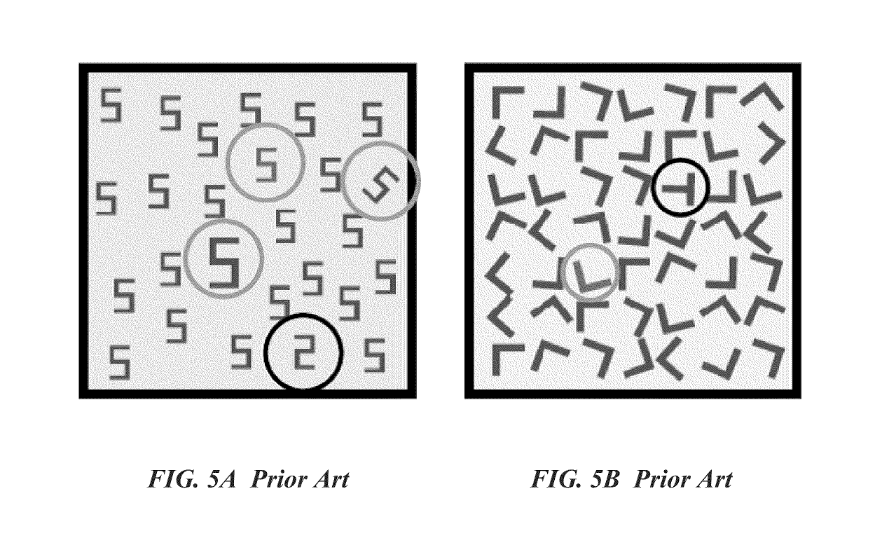

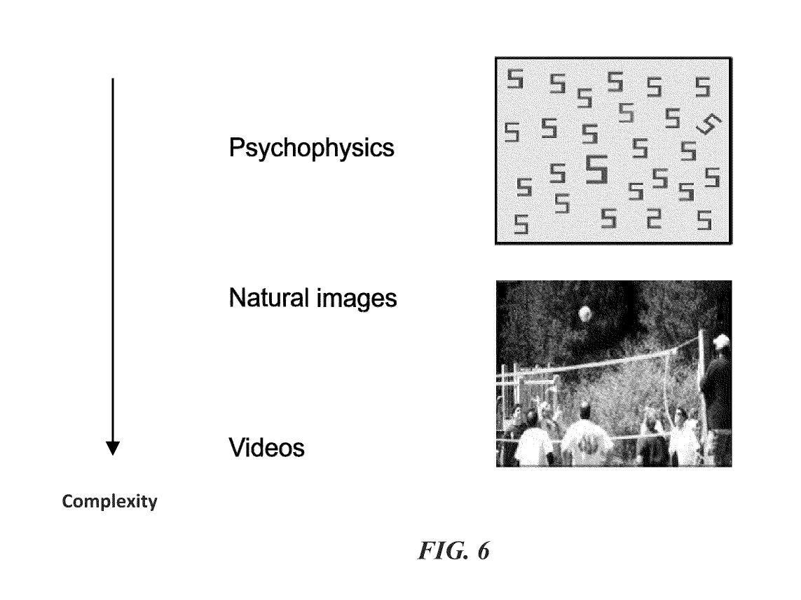

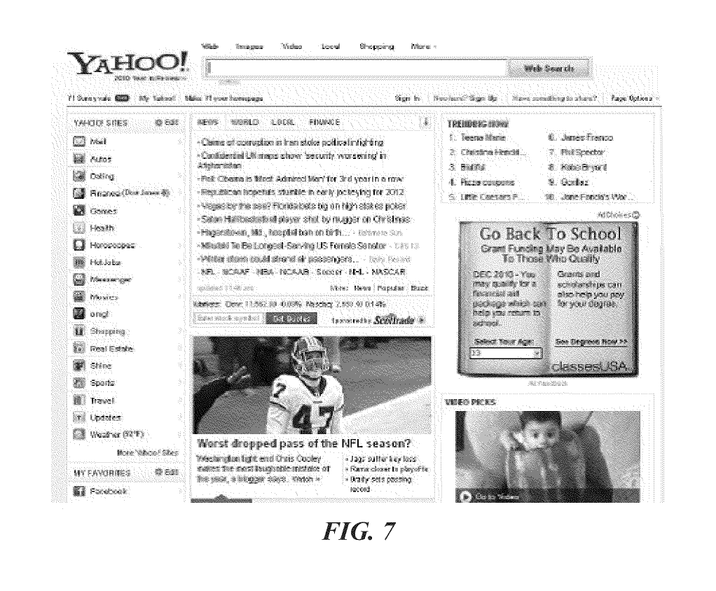

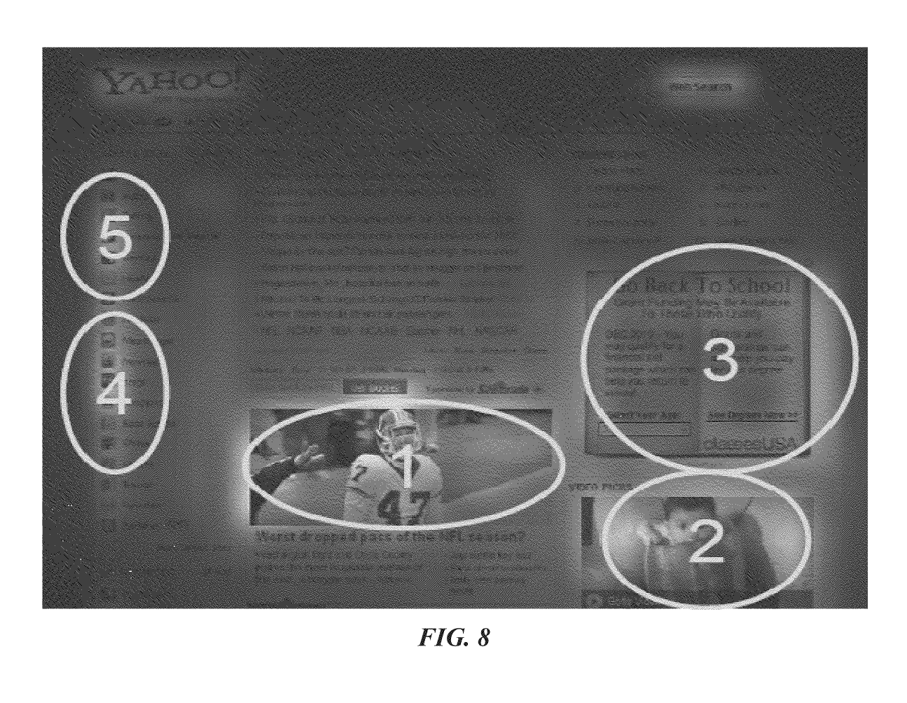

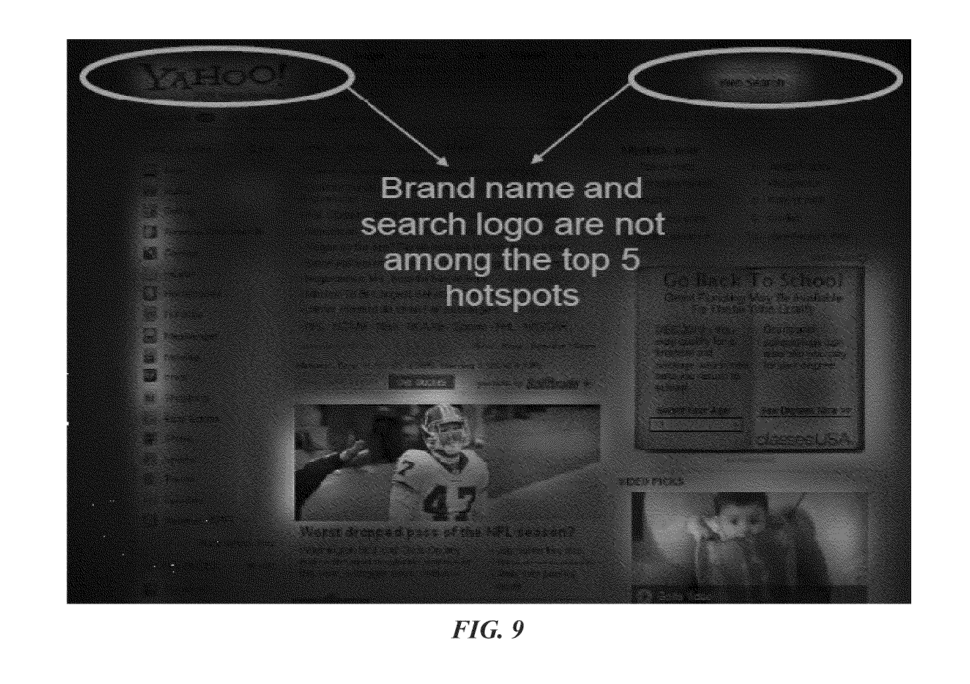

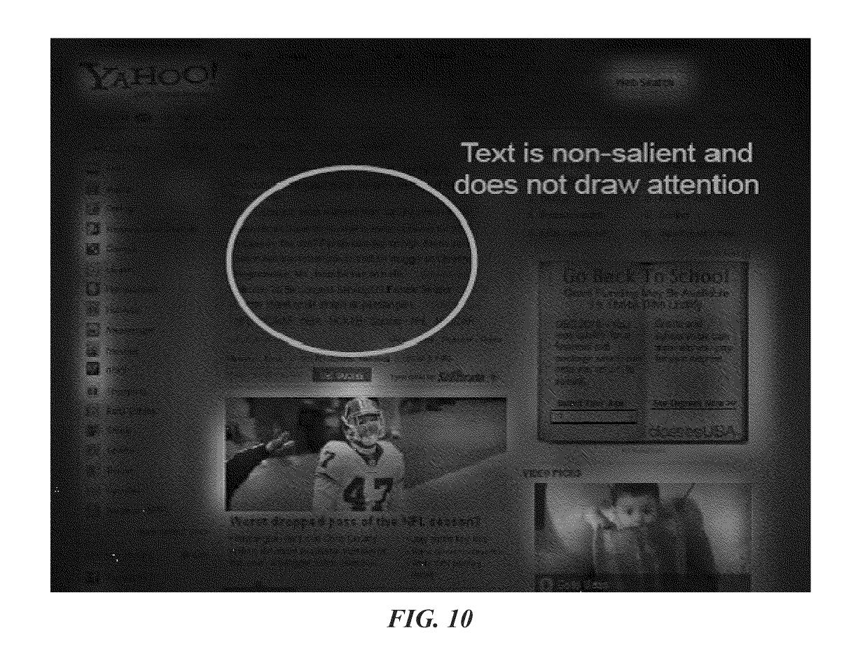

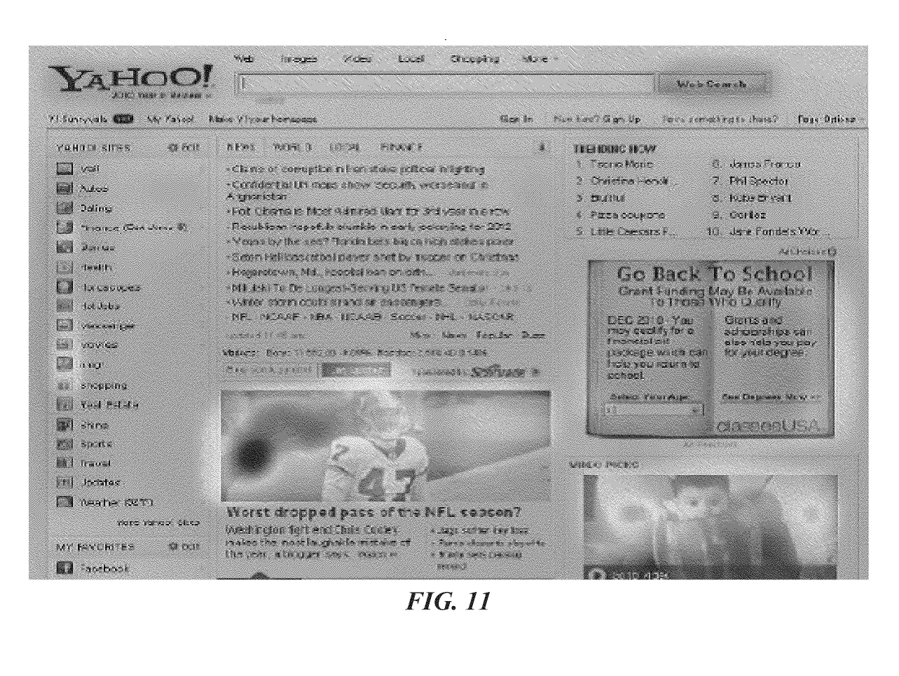

An embodiment of the present invention uses a model of human visual attention (Hou & Zhang, 2008); inspired by information processing in the primate visual cortex, to predict what users might see on a web page in the first few seconds. Referring now to FIG. 2, the model 250 receives the screenshot 210 of a webpage as input, and outputs a saliency map 260, which predicts a probability distribution over user attention and gaze, i.e., it predicts the probability with which users might see or gaze at an item on the webpage. As mentioned earlier, user gaze may be determined using eye trackers, but this process is slow, expensive and not scalable. Here, we use the saliency model to predict user attention and gaze. In other words, the saliency map 260 shows hotspots in the display. The hotspots represent those items that are more likely to initially grab a user's attention. These hotspots can be depicted as red (fiery) areas on the map, or otherwise distinguished by color, auras, highlighting, blinking, and other distinguishing characteristics. The hotspots offer a prediction of what a user will focus on in the first few seconds when viewing the page.

This saliency model we use is derived from insights in neuroscience and cognitive psychology which show that visual attention is attracted (in some cases, strongly captured) by display items whose visual properties (color, orientation, brightness, motion) are very different from the surrounding display items. Orientation here refers to whether the item on a page is horizontal or vertical or tilted along some direction. For example, a red Coca Cola can against a green background is salient and attracts attention due to the high color contrast, whereas the same red Coca Cola can in an orange/reddish background is not salient and does not attract attention due to the poor color contrast. Another example is that a tilted building surrounded by several vertical buildings is salient due to the difference in orientation.

From early visual cortex studies, eye tracking experiments have shown that saliency is an important driving factor of attention in the first few seconds, be it watching videos, static images, natural or synthetic displays. Since saliency depends on low-level visual processes, is precognitive and involves involuntary attention mechanisms, it is a basic attention-driving mechanism that can be found across species (e.g., barn owl, archer fish, cat, monkey and human), independent of gender, age, and race. Motivated by these facts, we use saliency-based methods to determine hot spots and predict what users might see on web pages in the first few seconds.

We provide a service and a system implementation to use this model in a new application domain, namely to evaluate webpage designs and layouts by testing whether the “important” page elements appear salient and attract attention. “Importance” here can be defined either in terms of importance/relevance to the user (based on user profile and interests), or importance to the publisher (based on expected revenue from various page elements, e.g., ads).

The importance of page elements can be inferred in many cases. For example, the advertisement is an important page element for the advertiser; the brand logo and content are important page elements for the publisher; content related to the users' search queries are important page elements for the user. Alternatively, the importance of page elements can be explicitly stated as an input to the model, e.g., designers may specify that the mail or search logo is an important page element. In this case, since the model does not by itself know where these important elements are on the page, the x,y coordinates of the bounding box (smallest rectangle that bounds the element) must also be provided as an input to the model, along with the web page. This can be done manually by the designer/publisher, or automatically by using computer vision tools that can provide the coordinates of elements on a rendered page. One known method to get the coordinates is to run a Javascript that provides the mouse x,y coordinates on a web page. The user simply places the mouse at one corner of the bounding box, notes the x,y coordinates and moves to the next corner to capture those coordinates, until done.

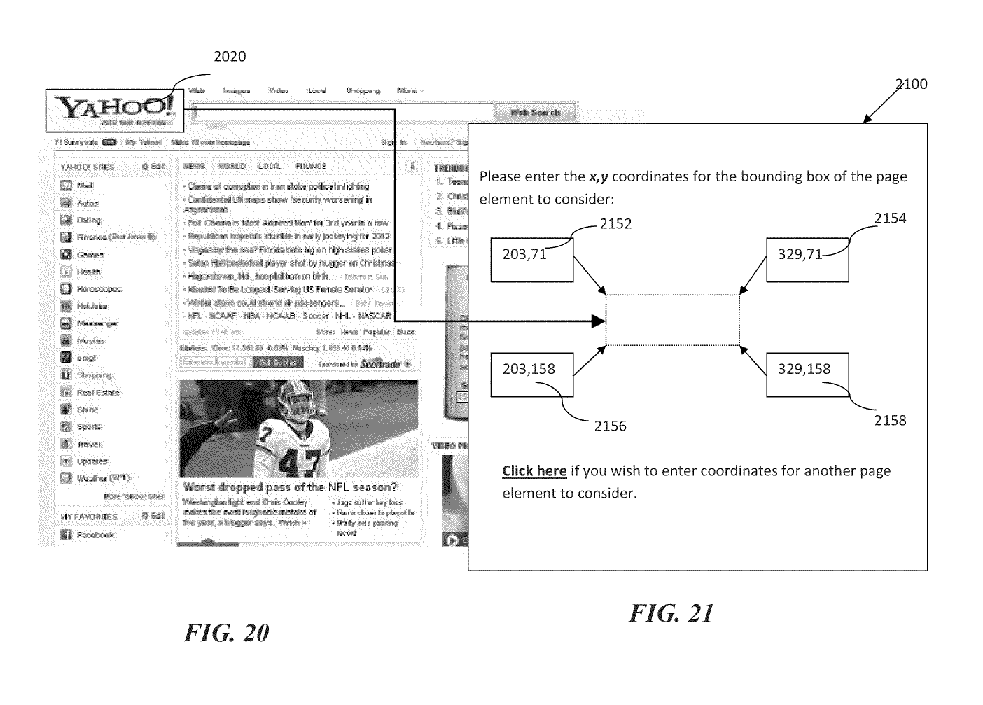

Referring now to FIGS. 20 and 21, once all four corners of the bounding box 2020 are known, in one embodiment the user accesses an interface 2100 provided by the model to supply the four coordinates 2152, 2154, 2156, and 2158 to the model. The four coordinates represent the bounding box 2020. Given the bounding box 2020 of the important element(s), the model computes the total saliency of those elements and then can be used to evaluate webpage designs to test whether the important page elements are rendered visually salient. Note, however, that the model can also be used in the absence of such information, by predicting user attention on the design.

The advantages to this method over the current methods are that it is predictive without requiring users to submit training data; it is fast; and it is inexpensive, scalable, and automated. The model can be trained to learn user bias towards page locations, features, content, and the like. We use saliency-based methods on a large scale to evaluate page/ad effectiveness on the Web and relate it to tangibles like clicks and page dwells. In addition, the proposed system implementation of logging page screenshots and saliency of page elements, in addition to standard information in click logs, is novel. This will enable log analysis to reveal the relationship between saliency and click-through-rates (CTR), and page dwells.

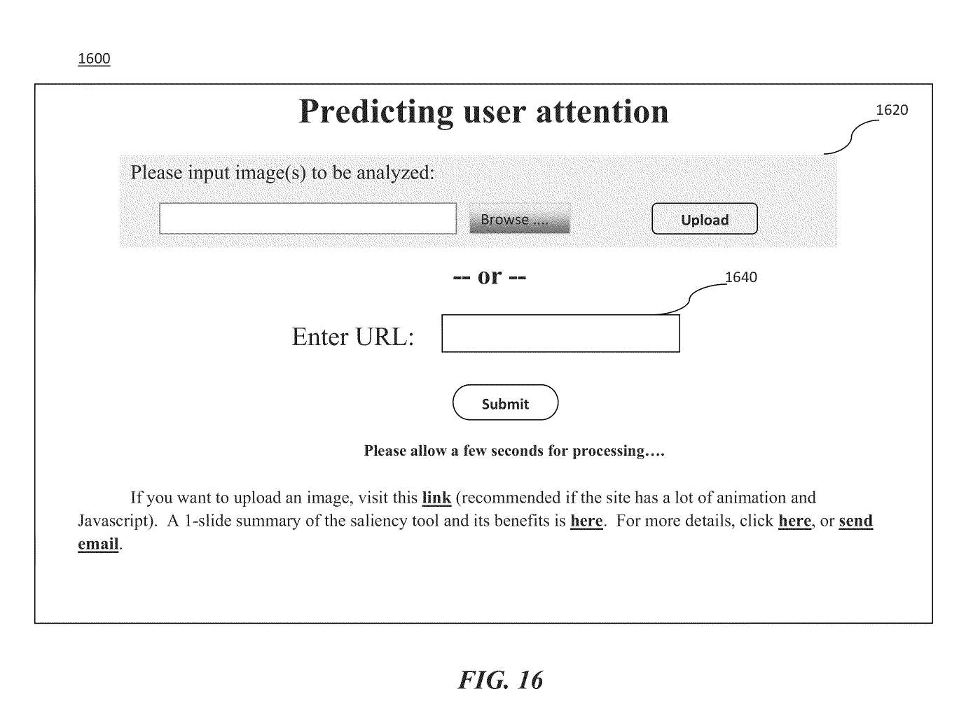

Also, the internal web service that we provide to automate saliency computation on any URL or page screenshot is novel. Referring now to FIG. 16, this interface 1600 allows the user to input a URL (uniform resource locator) 1640 such as www.yahoo.com. The web service, according to an embodiment of the invention, automatically extracts the screenshot of the web page at www.yahoo.com. In the alternative, the input can be the screenshot 1620 of the web page or an advertisement design to be evaluated.

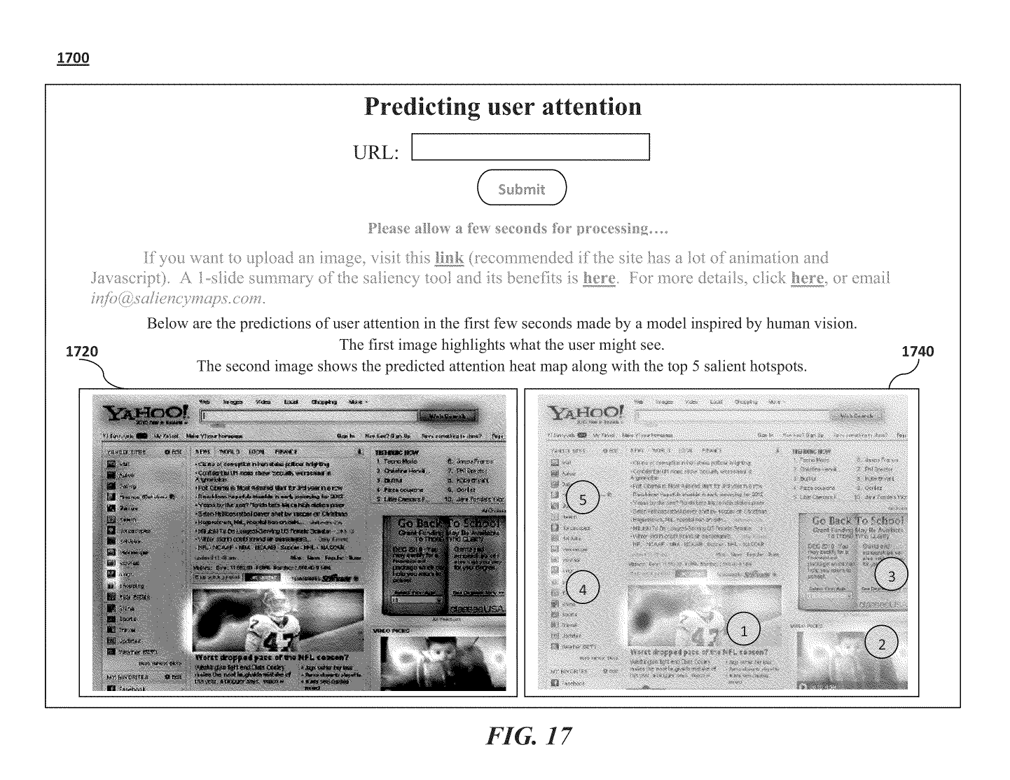

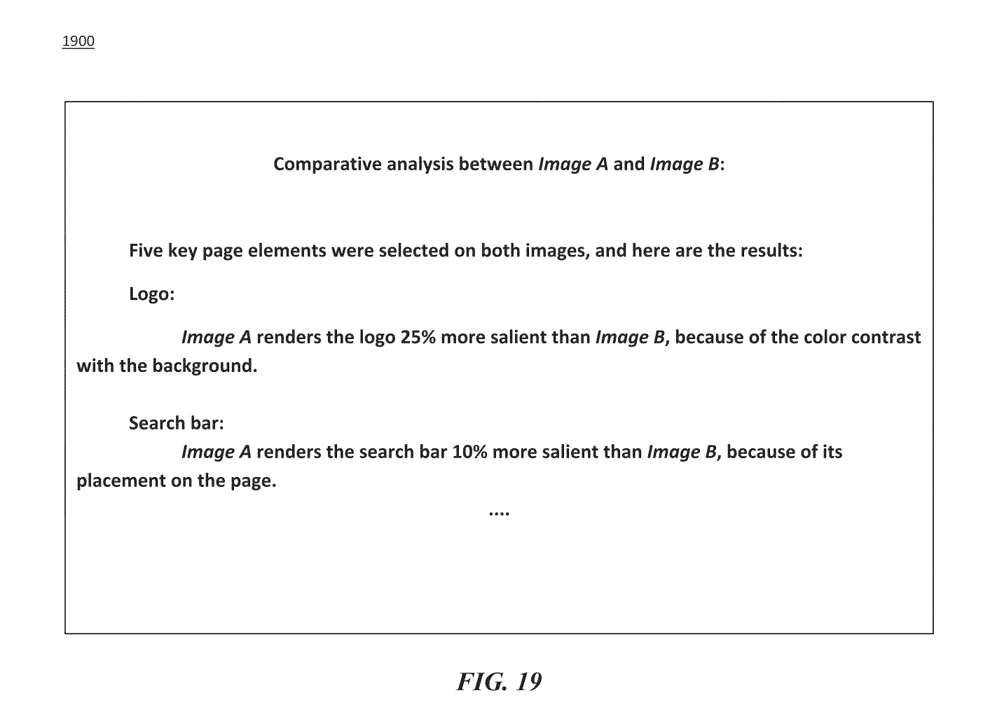

Referring now to FIG. 17, the web service then outputs several things: in addition to a visualization of the predicted user gaze or attention heat map 1720, the interface 1700 provides a ranking 1740 of the top salient hotspots that will catch the users' eye. Optionally, the web service generates a summary statistics report 1900 as shown in FIG. 19 when comparing several designs, such as reporting the mean saliency of the key page elements along with their confidence intervals, and numbers such as “design A renders the key elements (e.g., brand name/logo) x% more salient than design B.” As mentioned previously, an analysis on important elements can be done by providing the bounding box of the elements as input to the model.

A further breakdown of information may be provided in the form of comparative analysis of visual features that contribute to the saliency of the hotspot. For example, a red Coca Cola can against a green background is salient due to the color contrast, while orientation, brightness and other visual features may not contribute much. The comparative analysis provides feedback and insights to designers and advertisers on the efficacy of their designs. For web portals like Yahoo!, advertisements may be displayed on web pages resulting from a user-defined search based upon one or more search terms. Such advertising is most beneficial to users, advertisers and web portals when the displayed advertisements are relevant to the web portal user's interests. Thus, a variety of techniques have been developed to infer the user's interests/intent and subsequently target the most relevant advertising to that user.

The proposed method provides a novel way to improve advertisement effectiveness by enabling ad selection based on saliency in addition to the existing approach of presenting targeted advertisements to those users interested in receiving product information from various sellers by employing demographic characteristics (i.e., age, income, sex, occupation, etc.) for predicting the behavior of groups of different users. For example, given a set of advertisements that are targeted to the user based on demographics, the proposed method could be used to select the advertisement that is most salient and hence even more likely to be noticed by the user.

Method embodiments.

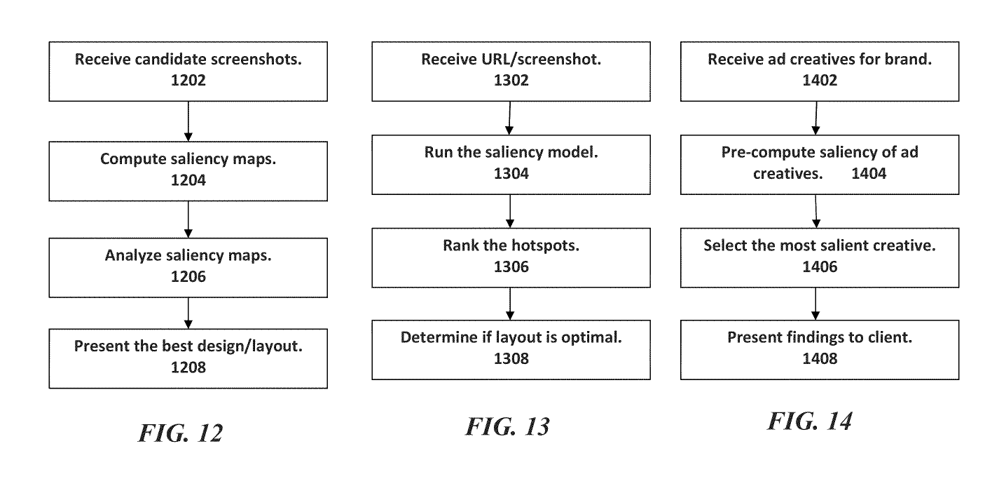

Referring now to FIG. 12 we show a flowchart 1200 of a method for evaluating webpage and/or online advertisement effectiveness in terms of saliency, according to an embodiment of the present invention. In step 1202 we receive screenshots of candidate web pages, designs or ad layouts. Alternatively, we can receive as input a URL and the system generates the screenshot. In step 1204 we run the screenshots 210 against the saliency model 250 to compute the corresponding saliency maps 260. In step 1206 we analyze the saliency maps to determine the optimal design or layout that maximizes the saliency of the “important” page elements. In step 1208 we present the winning design/layout. Note that this method can be performed for a fee.

Referring now to FIG. 13 we show a flowchart 1300 of a method for providing a web service to analyze web pages, according to an embodiment of the present invention. We provide an internal web service that in step 1302 accepts any URL or screenshot of a web page or ad, and outputs (1) an image that highlights what users might see in the first few seconds, and (2) an attention heat map where the salient hotspots are in red and non-salient elements are in blue, along with a rank order marking of the top five salient hotspots. This can be used to test whether page elements such as the brand/ad/other important page elements are salient and will catch user attention. In step 1304 we run the web page against the saliency model 250 to generate a corresponding saliency map 260. In step 1306 we rank the hotspots. In step 1308 we use the ranked hotspots to determine whether the “important” page elements have a high ranking within the hotspots.

Referring now to FIG. 14, we show a flowchart 1400 of a method to determine saliency-based ad/brand effectiveness, according to an embodiment of the present invention. For each brand, we receive ad creatives in step 1402. In step 1404 we pre-compute saliency of various ad creatives, and in step 1406 we select the one that renders the brand name most salient, and hence more likely to be noticed and recalled. In step 1408 we present the findings to the client.

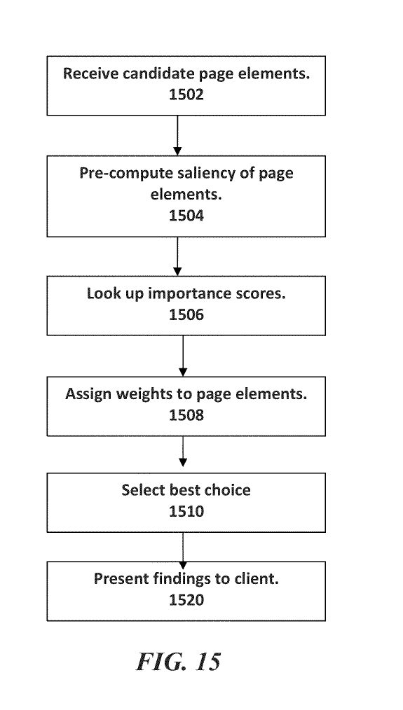

Referring now to FIG. 15, we show a flowchart 1500 of a method for saliency-based page/ad optimization, according to an embodiment of the present invention. In step 1502 we receive various candidate page elements. In step 1504 we pre-compute the saliency of the various page elements (e.g., ads, images, non-images). In step 1506, at run-time, we look up the ‘importance’ score of each page element to the user (or publisher), and in step 1508 we assign weights to the page elements. In step 1510 we enable personalization by selecting the page elements that maximize saliency weighted by importance. In step 1510 we present the findings to the client.

Benefits and advantages of the invention.

General benefits: Unlike existing methods that require a huge amount of user data for training—thus slow and expensive—our proposed method is fast, cheap and scalable as it is predicts user attention in the first few seconds on page without requiring data from even a single user, in order to evaluate page designs/layouts. Given the importance of page elements to the user and/or publisher (e.g., user preference for various topics on page, or publisher's expected revenue from the various page elements), the model can be used near run time to compare several candidate designs or layouts and present the winning design/layout to the user, that will maximize user attention on the preferred page elements.

Specific applications: 1) evaluating ad & brand effectiveness (testing whether the ad/brand appear salient on page and attract attention, if not, tuning visual properties to improve salience); 2) evaluating ad placement and layout (where should the ad be placed to attract more attention); 3) scalable evaluation of web page and advertisement designs and their impact on click-through rates (CTRs) and page dwells; and 4) predicting the top hotspots of user attention and generating summary statistics, ranking and comparative analysis by features.

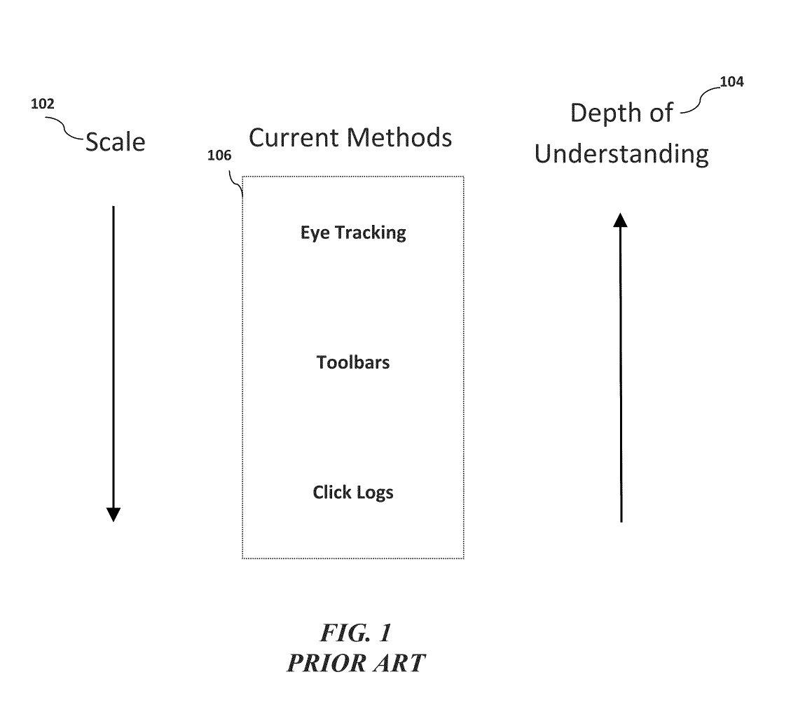

FIG. 1 Hardware Embodiment.

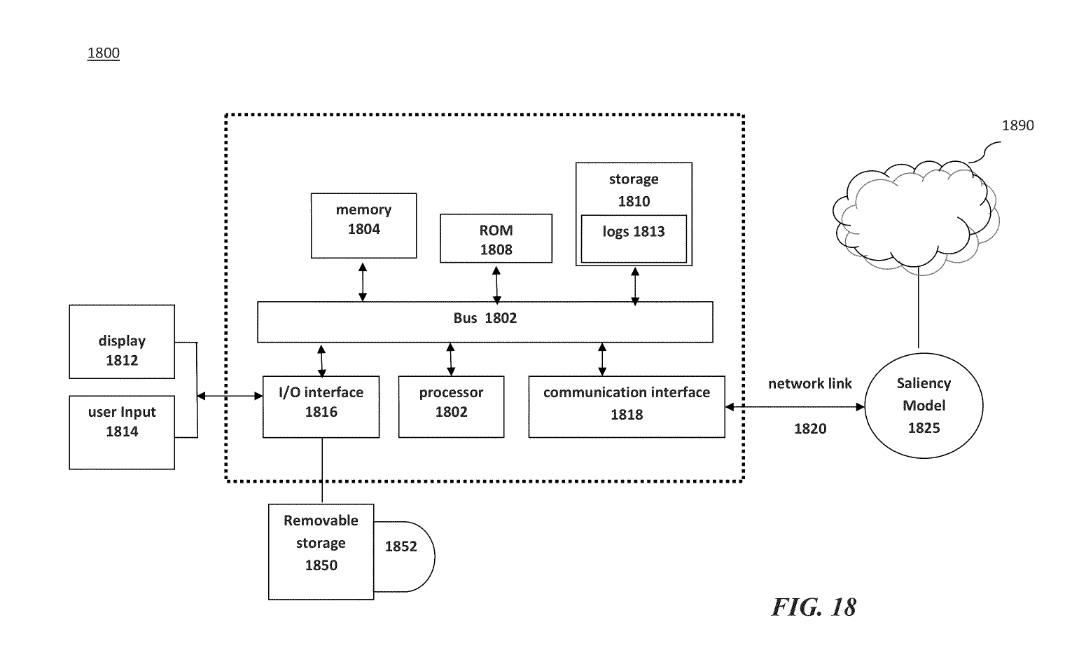

Referring now to FIG. 18, there is provided a simplified pictorial illustration of an information processing system 1800 for saliency-based evaluation of web page design and layouts in which the present invention may be implemented. For purposes of this invention, computer system 1800 may represent any type of computer, information processing system or other programmable electronic device, including a client computer, a server computer, a portable computer, an embedded controller, a personal digital assistant, and so on. The computer system 1800 may be a stand-alone device or networked into a larger system. Computer system 1800, illustrated for exemplary purposes as a networked computing device, is in communication with other networked computing devices (not shown) via network 1820. As will be appreciated by those of ordinary skill in the art, network 1820 may be embodied using conventional networking technologies and may include one or more of the following: local area networks, wide area networks, intranets, public Internet and the like.

In general, the routines which are executed when implementing these embodiments, whether implemented as part of an operating system or a specific application, component, program, object, module or sequence of instructions, will be referred to herein as computer programs, or simply programs. The computer programs typically comprise one or more instructions that are resident at various times in various memory and storage devices in an information processing or handling system such as a computer, and that, when read and executed by one or more processors, cause that system to perform the steps necessary to execute steps or elements embodying the various aspects of the invention.

Throughout the description herein, an embodiment of the invention is illustrated with aspects of the invention embodied solely on computer system 1800. As will be appreciated by those of ordinary skill in the art, aspects of the invention may be distributed amongst one or more networked computing devices which interact with computer system 1800 via one or more data networks such as, for example, network 1820. However, for ease of understanding, aspects of the invention have been embodied in a single computing device—computer system 1800.

Computer system 1800 includes processing device 1802 which communicates with an input/output subsystem 106, memory 104, storage 110 and network 110. The processor device 102 is operably coupled with a communication infrastructure 122 (e.g., a communications bus, cross-over bar, or network). The processor device 102 may be a general or special purpose microprocessor operating under control of computer program instructions 132 executed from memory 104 on program data 134. The processor 102 may include a number of special purpose sub-processors such as a comparator engine, each sub-processor for executing particular portions of the computer program instructions. Each sub-processor may be a separate circuit able to operate substantially in parallel with the other sub-processors.

Some or all of the sub-processors may be implemented as computer program processes (software) tangibly stored in a memory that perform their respective functions when executed. These may share an instruction processor, such as a general purpose integrated circuit microprocessor, or each sub-processor may have its own processor for executing instructions. Alternatively, some or all of the sub-processors may be implemented in an ASIC. RAM may be embodied in one or more memory chips.

The memory 1804 may be partitioned or otherwise mapped to reflect the boundaries of the various memory subcomponents. Memory 1804 may include both volatile and persistent memory for the storage of: operational instructions for execution by CPU 1802, data registers, application storage and the like. Memory 1804 preferably includes a combination of random access memory (RAM), read only memory (ROM) and persistent memory such as that provided by a hard disk drive. The computer instructions/applications that are stored in memory 1804 are executed by processor 1802. The computer instructions/applications and program data can also be stored in hard disk drive for execution by processor device 1802. Storage 1810 may be located within the system 1800 or off-site. Storage 1810 may contain the logs 1813 for the screenshots and saliency data.

Those skilled in the art will appreciate that the functionality implemented within the blocks illustrated in the diagram may be implemented as separate components or the functionality of several or all of the blocks may be implemented within a single component. The I/O subsystem 1816 may comprise various end user interfaces such as a display, keyboards, and a mouse. The I/O subsystem 1816 may further comprise a connection to the Internet 1890.

The computer system 1800 may also include a removable storage drive 1850, representing a floppy disk drive, a magnetic tape drive, an optical disk drive, etc. The removable storage drive 1850 reads from and/or writes to a removable storage unit 120 in a manner well known to those having ordinary skill in the art. Removable storage unit 1852, represents a floppy disk, a compact disc, magnetic tape, optical disk, CD-ROM, DVD-ROM, etc. which is read by and written to by removable storage drive 1850. As will be appreciated, the removable storage unit 1852 includes a non-transitory computer readable medium having stored therein computer software and/or data.

The computer system 1800 may also include a communications interface 1818. Communications interface 1818 allows software and data to be transferred between the computer system and external devices. Examples of communications interface 1818 may include a modem, a network interface (such as an Ethernet card), a communications port, a PCMCIA slot and card, etc. Software and data transferred via communications interface 1818 are in the form of signals which may be, for example, electronic, electromagnetic, optical, or other signals capable of being received by communications interface 1818.

In this document, the terms “computer program medium,” “computer usable medium,” and “computer readable medium” are used to generally refer to both transitory and non-transitory media such as main memory 1804, removable storage drive 1850, a hard disk installed in hard disk drive, and signals. These computer program products are means for providing software to the computer system 1800. The computer readable medium 1852 allows the computer system 1800 to read data, instructions, messages or message packets, and other computer readable information from the computer readable medium 1852.

Therefore, while there has been described what is presently considered to be the preferred embodiment, it will understood by those skilled in the art that other modifications can be made within the spirit of the invention. The above description(s) of embodiment(s) is not intended to be exhaustive or limiting in scope. The embodiment(s), as described, were chosen in order to explain the principles of the invention, show its practical application, and enable those with ordinary skill in the art to understand how to make and use the invention. It should be understood that the invention is not limited to the embodiment(s) described above, but rather should be interpreted within the full meaning and scope of the appended claims.

We claim:

1. A method for evaluating a web design, comprising:
using an interface configured for receiving input comprising page elements;
using a processor device operably coupled with the interface, said processor device configured to perform:
deriving a plurality of key page elements from the input;
running a saliency model on the input to derive hot spots representing those items that are most likely to initially obtain a viewer's attention;
comparing positions of the hot spots to placement of the plurality of the key page elements to determine effectiveness of the placement of the key page elements; and
presenting a saliency map depicting the hotspots in the page elements, said hotspots comprising a probability distribution over user attention and gaze, based on the comparison.

2. The method of claim 1 further comprising:
relating the key page elements to tangibles such as clicks, conversions and page dwells; and
positioning advertisements on a web page based on the saliency map.

3. The method of claim 1 further comprising:
logging page screenshots and saliency of the key page elements.

4. The method of claim 1 further comprising:
training the method to learn user bias towards the key page elements.

5. The method of claim 1 further comprising an initial step of:
generating an interface to receive the input.

6. The method of claim 5 wherein receiving the input comprises receiving one of: a web page, a uniform resource locator, a design layout, ad creatives, and a screenshot of a web page.

7. The method of claim 6 further comprising extracting a screenshot of a web page when the input comprises the uniform resource locator.

8. The method of claim 6 further comprising:
receiving multiple inputs of a same kind;
comparing the saliency of the multiple inputs; and
outputting a mean saliency of the key page elements, along with their confidence intervals.

9. The method of claim 6 further comprising providing a comparative analysis of visual features that contribute to the saliency of the hot spots.

10. The method of claim 1 further comprising receiving as input an indication of which page elements are the key page elements.

11. The method of claim 1 further comprising ranking the page elements to correspond to the hot spots.

12. A computer-implemented system for evaluating a web design comprising:
a memory comprising computer program instructions for:
receiving input comprising page elements;
deriving a plurality of key page elements from the input;
running a saliency model on the input to derive hot spots representing those items that are most likely to initially obtain a viewer's attention;
comparing positions of the hot spots to placement of the plurality of the key page elements to determine effectiveness of the placement of the key page elements; and
presenting a saliency map depicting the hot spots in the page elements, said hot spots comprising a probability distribution over user attention and gaze, based on the comparison; and
a processor device configured to execute the computer program instructions.

13. The computer-implemented system of claim 12 wherein the memory further comprises instructions for:
relating the key page elements to tangibles such as clicks, conversions and page dwells; and
positioning advertisements on a web page based on the saliency map.

14. The computer-implemented system of claim 12 further comprising:
storage for logging page screenshots and saliency of the key page elements.

15. The computer-implemented system of claim 12 further comprising:
an interface configured to receive the input, wherein receiving the input comprises receiving one of: a web page, a uniform resource locator, a design layout, ad creatives, and a screenshot of a web page.

16. The computer-implemented system of claim 15 wherein the memory further comprises computer program instructions for extracting a screenshot of a web page when the input comprises the uniform resource locator.

17. The computer-implemented system of claim 15 wherein the memory further comprises computer program instructions for:
receiving multiple inputs of a same kind;
comparing the saliency of the multiple inputs; and
outputting a mean saliency of the key page elements, along with their confidence intervals.

18. The computer-implemented system of claim 15 further comprising providing a comparative analysis of visual features that contribute to the saliency of the hot spots.

19. The computer-implemented system of claim 12 wherein the memory further comprises computer program instructions for ranking the page elements to correspond to the hot spots.

20. The computer-implemented system of claim 12 wherein the saliency model is derived from fields of neuroscience and cognitive psychology which find that visual attention is attracted to items whose visual properties are substantially different from surrounding items.

21. The computer-implemented system of claim 14 wherein the memory further comprises computer program instructions to perform log analysis to reveal a relationship between saliency and click-through-rates.

22. A computer program product comprising a computer-readable storage medium with computer-executable instructions enabling a computer device to perform:
receiving input comprising page elements;
deriving a plurality of key page elements from the input;
running a saliency model on the input to derive hot spots representing those items that are most likely to initially obtain a viewer's attention;
comparing positions of the hot spots to placement of the plurality of the key page elements to determine effectiveness of the placement of the key page elements; and
presenting a saliency map depicting the hotspots in the page elements, said hot spots comprising a probability distribution over user attention and gaze, based on the comparison.

23. The computer program product of claim 22 further comprising computer-executable instructions further enabling a computer to perform:
logging page screenshots and saliency of the key page elements.

24. The computer program product of claim 22 further comprising computer-executable instructions further enabling a computer to perform:
generating an interface configured to receive the input, wherein receiving the input comprises receiving one of: a web page, a uniform resource locator, a design layout, ad creatives, and a screenshot of a web page.

25. The computer program product of claim 22 further comprising computer-executable instructions further enabling a computer to perform:
comprising providing a comparative analysis of visual features that contribute to the saliency of the hot spots
